(19) United States
(12) Patent Application Publication
(10) Pub. No.: US 2002/0165798 A1
(43) Pub. Date: Nov. 7, 2002

(54) Method and configuration for charging for a service

(76) Inventors: Rudiger Hausmann, Penzberg (DE); Peter Moritz, Haar (DE)

Correspondence Address: LERNER AND GREENBERG, P.A., Post Office Box 2480, Hollywood, FL, 33022-2480, US

(21) Appl. No.: 10/139,170

(22) Filed: May 6, 2002

(30) Foreign Application Priority Data
May 4, 2001 (EP) 01 110 876.8

(51) Int. Cl. G06F 17/60

(52) U.S. Cl. 705/26; 705/39

(57) ABSTRACT

The method enables all-inclusive charging for a service which is provided by a service operator and covers, in particular, the granting of access to an IP network and/or the delivery of content in a telecommunications and data network. The charging is effected on the basis of an electronic credit associated with a user.

### BACKGROUND OF THE INVENTION

Field of the Invention

The invention relates to a method and an apparatus for charging for a service which is provided by a service operator and covers, in particular, the granting of access to an IP network and/or the delivery of content in a telecommunications and data network on the basis of a prepaid electronic credit associated with a user.

Various methods for charging for services in a data and telecommunications system, particularly the mobile radio networks and the Internet, are known from the prior art. Normally, services are paid for by means of credit card payment, transfer or cash payment to an account associated with a service provider or operator. In this context, the costs are often billed on the basis of the time spent using the service. In another form of charging, charges are levied on the basis of a transferred volume of data. Mixed charging, which takes account of length of time and volume of data, is also part of the prior art.

The scope of services is dependent on the service provider's service range. Simple services include the provision of a connection between a supply facility associated with the service provider and the user's terminal via a data line and a further connection (link) via appropriate gateways to a data network—normally the Internet. Other services provided, such as e-mail, access to newsgroups and storage space for personal data and/or for setting up an HTML page on the Internet (homepage), are normally likewise part of the scope of a service package provided by service providers.

Advantages of single-item charging can be found, in particular, in accounting to the exact second, detailed service records per accounting period on request and in the ability to dial up the service provider using any desired telecommunications device.

A more recently popular form of charging is the so-called flat rate. There, a fixed sum is paid to the service provider at particular intervals of time—preferably on a monthly basis—and is used to pay for all the service provider's services for the relevant period of time. Other options, particularly for private customers, are setting up a basic charge in conjunction with a charge which is dependent on usage time, or having a charge which is exclusively dependent on usage time—that is to say with no basic charge—on the basis of a prepaid credit facility.

Accounting using a flat rate charge proves to be inflexible, since this charge is always arranged for a previously determined, fixed period of use. If the user's usage habits vary, however, new all-inclusive arrangements need to be made regarding the usage time. Such making of new arrangements has been found to be time-consuming and costly for the service provider, however. Changes under the existing charging systems are time-consuming and inconvenient for the user as well.

By contrast, the known prepaid systems allow thoroughly flexible use of the prepaid service(s) through single instances of access, which are also charged for singly in each case. This makes the services relatively expensive, however, which prevents large groups of service users or potential users from using a prepaid credit facility. Furthermore, many service users who work with both prepaid accounts and cards deliberately act with an eye on cost—that is to say limit their access times to a minimum.

However, it is an aim of providers of Internet services, such as Internet auctions, online banking or online warehouses, that as many users as possible have access to the Internet over an extended time—as permanently as possible—since the users are then generally active on the Internet over a relatively long time, and hence the generation of higher turnovers tends to be possible.

### SUMMARY OF THE INVENTION

It is accordingly an object of the invention to provide a method and an apparatus for charging for services, which overcomes the above-mentioned disadvantages of the heretoforeknown devices and methods of this general type and which allows charging for services in a communications and data network and affords cost advantages for heavy users and which the user himself can match easily and flexibly to his specific current requirements, and to provide a corresponding apparatus.

With the foregoing and other objects in view there is provided, in accordance with the invention, a method of charging for a service provided by a service operator, which comprises:

a) registering and installing at the service operator an electronic credit of a user during a telecommunications connection between a user terminal and a service operator server;

b) requesting a service provided by the service operator for an all-inclusive charge via the user terminal and transmitting a charging mode code identifying that all-inclusive charging is desired for using the requested service for a particular period of time or amount of time or amount of data;

c) registering the request and checking the user's credit in relation to the charging mode code in a processing unit associated with the service operator server;

d) debiting a predetermined electronic credit amount as an all-inclusive charge from the user's credit in accordance with the charging mode code;

e) enabling access of the user terminal to the service;

f) starting a timer or data volume counter associated with the user on the service operator server and storing an end time or end counter reading corresponding to the debited credit amount in a memory area associated with the user; and

g) outputting a control signal when the timer or data volume counter reaches the stored end time or end counter reading.

With the above and other objects in view there is also provided, in accordance with the invention, a configuration for carrying out the above-outlined method, i.e., a configuration for charging for a service provided by a service operator, comprising:

at least one customer terminal having an input device for inputting data for installing or for reading a prepaid electronic credit, and a service operator server to be connected to the customer terminal via a telecommunications and data network;

a registration unit for registering a request for a service that is subject to an all-inclusive charge, including reading a charging mode code;

a checking unit connected to the registration unit for checking a user's electronic credit for coverage of a credit amount to be debited and obtained from the charging mode code read by the registration unit;

a debiting unit connected to the registration unit for debiting the credit amount from the electronic credit;

a switching unit for enabling access by the user terminal when the checking unit returns a positive result based on the charging mode;

a charging unit selected from the group consisting of a timer and a data counter for recording a period of use or a length of use or a data volume transmitted to the user terminal within the context of the service, wherein the charging unit continues to run from a reading reached at an end of a previous instance of access whenever the service is requested using the user terminal;

a memory connected to the registration unit for storing an end timer or counter reading determined from the charging mode code and optionally from the start timer or counter reading; and

comparator and signal generator units connected to the charging unit and to the memory for outputting a control signal when the end reading is reached.

A fundamental concept of the inventive method is that of providing a flexible procedure which can be employed when a contract is signed between the service provider and the user relating to the logging of the service or services and which frees the user from the constraint of being tied down in advance to rigid forms of charging and usage times. This involves making a prepaid credit facility flexible to manage, so that the service(s) can be used separately and on the basis of the user's respective living circumstances.

With the proposed solution, the user's registering with the service operator server involves the arrangement of a plurality of permissible charging modes which are stored in a list showing an association with a charging mode code. If the user wishes to use a particular service—which is preferably likewise selected from a predetermined set of available services—he decides upon a charging mode and inputs the corresponding code on his terminal when requesting the service. On the basis of this code, the service operator server can use the aforementioned list to find the credit sum which corresponds to the desired scope of use and needs to be debited from the user's prepaid credit.

After a check has been carried out to determine whether the current credit level covers this credit sum, the service operator server performs a debit operation and simultaneously enables the desired service for the scope of use which has just been paid for. This can involve a particular (calendar) period, that is to say, by way of example, a day, a week or a month, etc., or else a length of time (determined according to amount), that is to say 24 or 100 hours of use, for example, or a predetermined transferable volume of data, that is to say, by way of example, 100 kbytes, 10 Mb, 1 Gb, etc. One particularly significant application of the proposed solution in practical (and economic) terms is charging for access to the Internet via a landline telephone line or a mobile radio terminal, that is to say on an HTTP or WAP basis.

However, the solution—which can be called “prepaid flat rate” for short—can also be used for access to intranets or databases in the widest sense, that is to say including music, video or game databases operated by “content providers”. The level of charges, i.e. the credit sum debited at an all-inclusive rate for a particular scope of use, is stipulated according to specific targets on the basis of the type of service.

Certain specific features will expediently also apply to the charging modes which can be selected: thus, for granting access to the Internet, the provision of various time-based and data-volume-based charging modes will probably be useful, whereas the use of services from a content provider is more likely to be charged for on the basis of data volume. In line with these various options, the operator server will generally keep both a timer and a data volume counter for the respective user and will also allocate him a memory area for storing the end time and end counter reading resulting from the debited credit sum. It goes without saying that for charging oriented to the scope of use (net usage time or data volume) the timer is stopped when access ends and is started again at the previously reached reading when the service is requested again, and the counter reading on the data volume counter is preserved when access is interrupted.

Once the stored end time or end counter reading has been reached, the operator server generates a control signal which can trigger various functions. Firstly—and, from the latter party's point of view, above all—this control signal effects changeover to single-item charging for all further use of the service (if and for as long as no further all-inclusive charging comes into effect). As an alternative to this, the control signal can block user access to the service.

Both variants need to be combined with the sending of a message to the user terminal which informs the user that the usage time subject to the all-inclusive charge has expired or that the transferred data volume paid for by the all-inclusive charge has been exhausted. He can then initiate another all-inclusive charging operation himself by means of a new call. As an alternative to this, the user's registering with the (charging) service can also involve stipulating that whenever a credit sum debited at an all-inclusive rate has been used up, another, equal sum is debited and the originally arranged charging mode is updated—until the prepaid credit has been exhausted.

The proposed method (and the corresponding arrangement) can be implemented as a supplementary service from a service or content provider with the service or content provider himself, that is to say on an operator server which is also used to provide access or the desired data. Equally, it can also be implemented as an independent service for “foreign” service or content providers, however. In the latter case, the service operator server for the charging service undertakes the information transmission, processing and checking operations which are important for implementing the invention and performs the (electronic) credit transfers and the enabling (and blocking) of user access to the service or content provider, but has nothing to do with providing the service which is actually used by the user.

It goes without saying that the method aspects cited above have corresponding arrangement and system aspects in an arrangement which is suitable for implementing the invention, especially since a hybrid software and hardware configuration will be used for implementation. These apparatus aspects are therefore not mentioned in full again at this point, but a few fundamental apparatus aspects are indicated. These include, firstly, suitable input means for installing the electronic credit (and possibly for inputting identification and authentication data) on the user terminal, for example a card reader for reading a magnetic strip card or chip card or a permanently installed nonvolatile memory. In the simplest case, the input means are produced by a keypad or else the microphone on a telephone, which the user can use to input a credit card number, for example (although this is not the preferred implementation, for security reasons).

Correspondingly, in the preferred implementation, the service operator server has a memory device which stores, on the basis of user, the respective electronic credit itself or a data record which represents the current credit level for the checking and transfer operations which are required for the invention.

Furthermore, the service operator server is provided with the necessary processing and memory device for registering the request for a service charged at an all-inclusive rate, including reading the charging mode code, for checking the credit and for performing the necessary credit transfers, and with the measurement and storage means (already mentioned briefly above) for recording the times and data volumes charged at an all-inclusive rate, and also with a signal generator device for outputting the signal which identifies the end of all-inclusive charging.

Other features which are considered as characteristic for the invention are set forth in the appended claims.

Although the invention is illustrated and described herein as embodied in a method and configuration for charging for a service, it is nevertheless not intended to be limited to the details shown, since various modifications and structural changes may be made therein without departing from the spirit of the invention and within the scope and range of equivalents of the claims. The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a basic block diagram of a communications system for illustrating the invention; and

FIG. 2 is a function block diagram of an exemplary embodiment of the configuration according to the invention.

### DESCRIPTION OF THE PREFERRED EMBODIMENTS

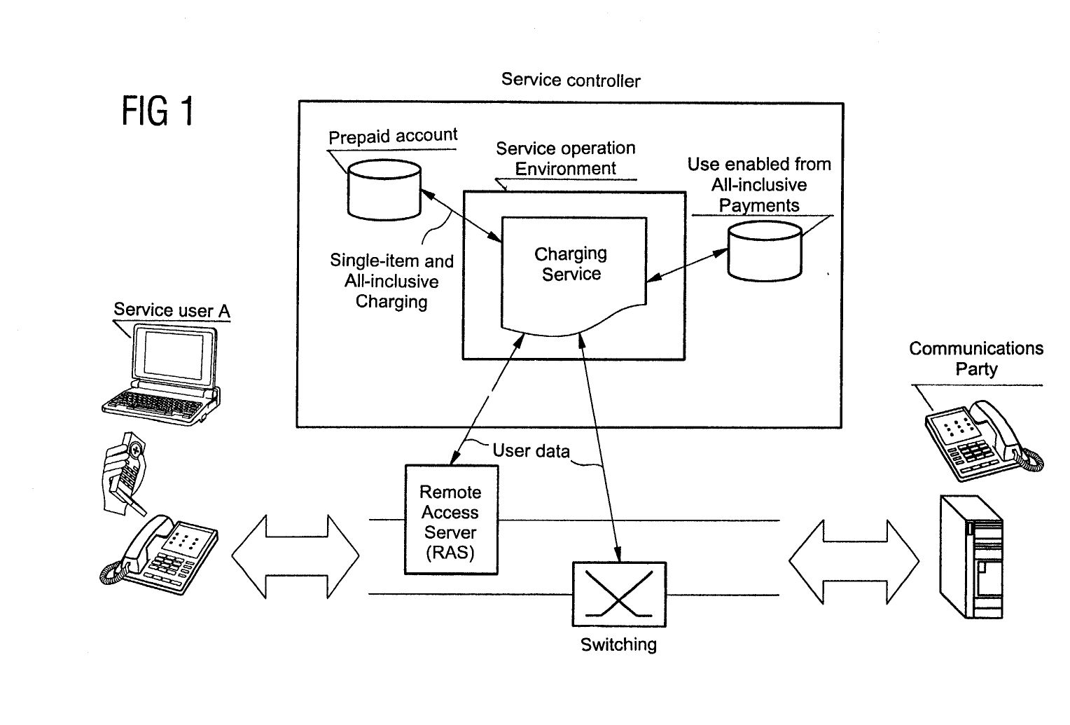

Referring now to the figures of the drawing in detail and first, particularly, to FIG. 1 thereof, there is shown, by way of illustration, a system wherein a service user A wishes to obtain access to a communications party using one of a plurality of user terminals (landline telephone, mobile telephone, or laptop) via a combined telecommunications and data network—specifically using a switching facility (shown symbolically as a switching matrix) or an access server or remote access server (RAS). The communications party is shown symbolically as another landline telephone or server. The access is subject to a cost and, according to the inventive method, is intended to be implemented for the service user A in an easily and flexibly settable manner using a prepaid account managed within the context of a charging service.

To this end, the charging service has a service controller which is implemented on a dedicated service operator server and uses a service operation environment using single-item and all-inclusive charging to provide the access required by the service user A when requested. As explained in general terms above, when the service user A has registered for all-inclusive charging from his prepaid account, this involves enabling usage from all-inclusive payments via the RAS, or switching on the basis of a concrete charging mode which has been input by the service user. During the period of all-inclusive charging, single-item charging is suppressed.

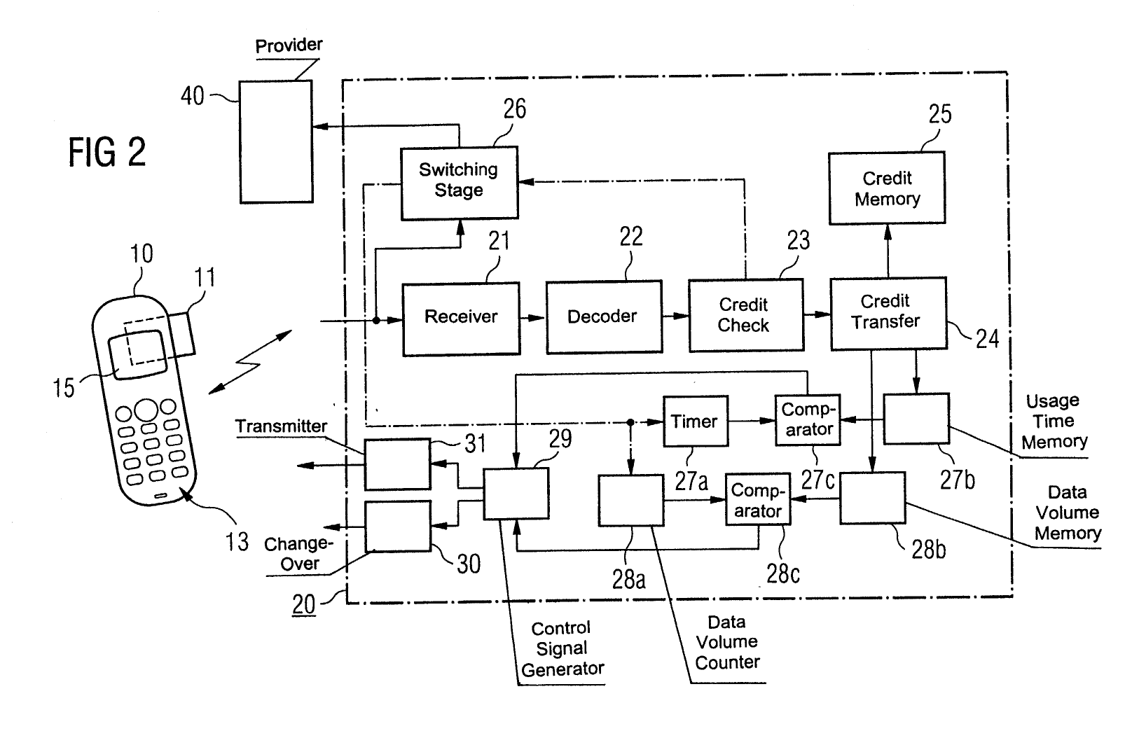

FIG. 2 uses a function block diagram to show, schematically, fundamental functional components (used for implementing the invention in one preferred example) of a mobile radio terminal 10 and of a service operator server 20 which are used to provide user access to a WAP service using “prepaid flat rate charging”.

The mobile radio terminal 10 is a largely conventional SIMLok mobile telephone with a prepaid card 11, an input keypad 13 and a display 15 which the user uses to make inputs under menu guidance provided by the service operator for the purpose of charging for WAP access. The connection between the mobile radio terminal 10 and the service operator server 20 is set up via a conventional (and therefore non-illustrated) mobile radio network to which the service operator server is connected via a gateway server.

The service operator server 20 has a reception device 21 for receiving a subscription call from the mobile radio terminal 10. The reception device 21 has a downstream-connected decoding stage 22 for decoding a charging mode code which is input by the user on the input keypad 13 on the mobile radio terminal 10. The service operator server 20 also has a credit checking unit 23 for checking the prepaid credit which is currently on the prepaid card 11 in the mobile radio terminal 10, and a credit transfer unit 24 for debiting a credit sum predetermined by the charging mode code from the user's prepaid card in a credit memory 25. The latter's specification is based, in the case of the configuration shown in FIG. 1, on stipulations made between the operator of the charging service and the communications party (service or content provider) called by the service user.

The credit checking unit 23, or alternatively the credit transfer unit 24, has a signal connection to a switching stage 26 for the purpose of enabling a connection between the mobile radio terminal 10 and a provider server 40 associated with an Internet provider. Once the check on the credit on the prepaid card 11 has returned a positive result, or in response to a credit transfer having been made for a period or scope of use which is determined by the charging mode code, the switching stage 26 provides the user with access (not subject to single-item charging) to the provider server 40 and blocks this access again as soon as the period or scope of use acquired by debiting the predetermined credit sum has elapsed or has been reached.

A timer 27a and a usage time memory 27b are used to record the time at which an arranged period of use has elapsed, and a data volume counter 28a and a data volume limit value memory 28b are used to record the time at which an arranged transferable data volume has been reached. Corresponding comparator units 27c and 28c then pass a signal to a control signal generator 29, which for its part outputs a control signal to a charging changeover unit 30 in order to change over from all-inclusive charging to single-item charging, and to a transmission unit 31 in order to inform the user that all-inclusive charging has expired.

In this—greatly simplified—illustration, it has been assumed (unrealistically) that subscription to the allinclusive charging service and also charging with the service operator server 20 and access to the provider server 40 are effected during a single, continuous connection. In practice, the functional units are designed such that a plurality of credit debiting operations are possible on the basis of a subscription which has been taken out once and, following a credit debiting operation, a plurality of new instances of access to the provider server 40 are possible (within the context of the arranged scope of use).

The implementation of the invention is not limited to the example described above, but rather is likewise possible in a multiplicity of modifications which are within the scope of those of skill in the pertinent art.

We claim:

1. A method of charging for a service provided by a service operator, which comprises:
a) registering and installing at the service operator an electronic credit of a user during a telecommunications connection between a user terminal and a service operator server;
b) requesting a service provided by the service operator for an all-inclusive charge via the user terminal and transmitting a charging mode code identifying that all-inclusive charging is desired for using the requested service for a particular period of time or amount of time or amount of data;
c) registering the request and checking the user's credit in relation to the charging mode code in a processing unit associated with the service operator server;
d) debiting a predetermined electronic credit amount as an all-inclusive charge from the user's credit in accordance with the charging mode code;
e) enabling access of the user terminal to the service;
f) starting a timer or data volume counter associated with the user on the service operator server and storing an end time or end counter reading corresponding to the debited credit amount in a memory area associated with the user; and
g) outputting a control signal when the timer or data volume counter reaches the stored end time or end counter reading.

2. The method according to claim 1, which comprises performing at least steps a) and b) under menu guidance in the course of a first connection between the user terminal and the service operator server.

3. The method according to claim 1, which comprises performing steps a) through g) under menu guidance in the course of a first connection between the user terminal and the service operator server.

4. The method according to claim 1, which comprises triggering, with the control signal output in step g), a changeover to single-item charging for all further use of the service.

5. The method according to claim 1, which comprises blocking, with the control signal output in step g), further user access to the service.

6. The method according to claim 1, which comprises controlling, with the control signal output in step g), a sending of a message to the user terminal.

7. The method according to claim 1, which comprises performing step a) simultaneously for a plurality of defined access call numbers or addresses for one or more user terminals.

8. The method according to claim 1, which comprises performing step a) and steps c) to g) with or by a first service provider providing a subscription/charging service, while a service from an access provider or content provider is requested in step b).

9. The method according to claim 1, which comprises reading the electronic credit from an access card equipped with a nonvolatile memory on the user terminal.

10. The method according to claim 9, which comprises also reading an identification data record from the access card.

11. The method according to claim 1, which comprises reading the electronic credit from a credit memory of the service operator server based on Input from the user terminal.

12. The method according to claim 1, which comprises reading the electronic credit and an identification data record from a credit and identification data memory of the service operator server based on input from the user terminal.

13. The method according to claim 1, which comprises, based on a specific input in step a), and following step g), automatically performing steps c) to f) repeatedly as long as the electronic credit covers the respective credit amounts to be debited.

14. The method according to claim 1, wherein the service provided by the service operator covers at least one of a granting of access to an IP network and a delivery of content in a telecommunications and data network.

15. The method according to claim 1, wherein the electronic credit is a prepaid electronic credit associated with a user.

16. A configuration for charging for a service provided by a service operator, comprising:
at least one customer terminal having an input device for inputting data for installing or for reading a prepaid electronic credit, and a service operator server to be connected to the customer terminal via a telecommunications and data network;
a registration unit for registering a request for a service that is subject to an all-inclusive charge, including reading a charging mode code;
a checking unit connected to said registration unit for checking a user's electronic credit for coverage of a credit amount to be debited and obtained from the charging mode code read by said registration unit;
a debiting unit connected to said registration unit for debiting the credit amount from the electronic credit;
a switching unit for enabling access by the user terminal when said checking unit returns a positive result based on the charging mode;
a charging unit selected from the group consisting of a timer and a data counter for recording a period of use or a length of use or a data volume transmitted to the user terminal within the context of the service, wherein said charging unit continues to run from a reading reached at an end of a previous instance of access whenever the service is requested using the user terminal;
a memory connected to said registration unit for storing an end timer or counter reading determined from the charging mode code and optionally from the start timer or counter reading; and
comparator and signal generator units connected to said charging unit and to said memory for outputting a control signal when the end reading is reached.

17. The configuration according to claim 16, wherein said input device on the user terminal comprises a card reader for reading a magnetic strip card or chip card.

18. The configuration according to claim 16, wherein said input device on the user terminal comprises a permanently installed nonvolatile memory.

19. The configuration according to claim 16, wherein said signal generator is connected to a charging control device for changing over from all-inclusive charging to single-item charging.

20. The configuration according to claim 16, which comprises a transmission device connected to said signal generator for sending a message to the user terminal.

21. The configuration according to claim 16, wherein a user terminal with an input device for installing and for reading the electronic credit has an associated plurality of access call numbers or addresses assigned thereto.

22. The configuration according to claim 21, wherein said user terminal with said input device has further terminals with no separate credit input devices assigned thereto.

23. The configuration according to claim 16, wherein the service operator server contains a credit memory for storing prepaid electronic credit or information about a credit level, and wherein said credit memory has a signal connection to the debiting unit.

24. The configuration according to claim 16, which comprises a credit monitoring unit for monitoring a level of the electronic credit and for outputting a warning signal if an available credit drops below a predetermined threshold value.
